(19) United States
(12) Patent Application Publication
(10) Pub. No.: US 2011/0311871 A1
(43) Pub. Date: Dec. 22, 2011

(54) NEGATIVE ELECTRODE FOR LITHIUM SECONDARY BATTERIES AND LITHIUM SECONDARY BATTERY

(75) Inventors: Atsushi Fukui, Kobe-shi (JP); Taizou Sunano, Kobe-shi (JP)

(73) Assignee: SANYO ELECTRIC CO., LTD., Osaka (JP)

(21) Appl. No.: 13/162,144

(22) Filed: Jun. 16, 2011

(30) Foreign Application Priority Data
Jun. 16, 2010 (JP) 2010-137078

(51) Int. Cl. H01M 4/62

(52) U.S. Cl. 429/217

(57) ABSTRACT

A negative electrode for lithium secondary batteries includes a negative electrode current collector and a negative electrode active material layer. The negative electrode active material layer is formed on the negative electrode current collector. The negative electrode active material layer contains a binder and negative electrode active material particles containing at least one of silicon and a silicon alloy. The binder is a polyimide resin formed by imidization of a tetracarboxylic acid or tetracarboxylic anhydride and a diamine. The diamine contains a diamine having at least one hydroxyl group.

### CROSS REFERENCE TO RELATED APPLICATIONS

The present application claims priority to Japanese Patent Application No. 2010-137078, filed in the Japan Patent Office on Jun. 16, 2010, the entire contents of which are incorporated herein by reference.

### BACKGROUND OF THE INVENTION

1. Field of the Invention

The present invention relates to a negative electrode for lithium secondary batteries and a lithium secondary battery including the negative electrode. The present invention relates to a negative electrode for lithium secondary batteries that uses negative electrode active material particles containing at least one of silicon and a silicon alloy, and to a lithium secondary battery including the negative electrode.

2. Description of Related Art

In recent years, there has been a demand for increasing the energy density of lithium secondary batteries. With this trend, a negative electrode active material that can further increase energy density over that of graphite materials, which have been commonly used as a negative electrode active material, has been actively studied. An example of such a negative electrode active material is an alloy material that contains an element such as Al, Sn, or Si and forms an alloy with lithium.

The alloy material that contains an element such as Al, Sn, or Si and forms an alloy with lithium is a negative electrode active material that occludes lithium through an alloying reaction with lithium, and has a volume specific capacity higher than that of graphite materials. Therefore, by using, as a negative electrode active material, the alloy material that contains an element such as Al, Sn, or Si and forms an alloy with lithium, a lithium secondary battery having high energy density can be obtained.

However, in a negative electrode that uses, as a negative electrode active material, the alloy material that contains an element such as Al, Sn, or Si and forms an alloy with lithium, the volume of the negative electrode active material is significantly changed when charge and discharge are performed. That is, when lithium is occluded and released. Thus, a negative electrode active material becomes readily powdered or a negative electrode mixture layer becomes readily detached from a current collector. When such phenomena occur, the current-collecting performance in the negative electrode decreases and the charge-discharge cycle characteristics of lithium secondary batteries become poor.

To solve such problems, for example, Japanese Published Unexamined Patent Application No. 2002-260637 (Patent Document 1) discloses a method in which a mixture layer that contains a polyimide binder and active material particles containing at least one of silicon and a silicon alloy is formed on a current collector and then the mixture layer is sintered in a non-oxidizing atmosphere. A negative electrode obtained by this method provides good cycle characteristics.

WO 04/004031 A1 (Patent Document 2), Japanese Published Unexamined Patent Application No. 2007-242405 (Patent Document 3), and Japanese Published Unexamined Patent Application No. 2008-34352 (Patent Document 4) disclose that good cycle characteristics can be achieved by optimizing a negative electrode binder contained in a negative electrode mixture layer. Patent Document 2 discloses that a polyimide having desired mechanical properties is used as a negative electrode binder. Patent Document 3 discloses that an imide compound obtained by decomposing a binder precursor composed of polyimide or polyamic acid through heat treatment is used as a negative electrode binder. Patent Document 4 discloses that a polyimide composed of 3,3′,4,4′-benzophenonetetracarboxylic dianhydride and m-phenylenediamine or 4,4′-diaminodiphenylmethane is used as a negative electrode binder.

### BRIEF SUMMARY OF THE INVENTION

There has still been a demand for further improving the charge-discharge cycle characteristics of lithium secondary batteries.

An object of the present invention is to provide a negative electrode for lithium secondary batteries that achieves a lithium secondary battery which uses at least one of silicon and a silicon alloy as a negative electrode active material and thus has good charge-discharge cycle characteristics.

A negative electrode for lithium secondary batteries according to the present invention includes a negative electrode current collector and a negative electrode active material layer. The negative electrode active material layer is formed on the negative electrode current collector. The negative electrode active material layer contains a binder and negative electrode active material particles containing at least one of silicon and a silicon alloy. The binder is a polyimide resin formed by imidization of a tetracarboxylic acid or tetracarboxylic anhydride and a diamine. The diamine contains a diamine having at least one hydroxyl group. The hydroxyl group of the diamine has high polarity. The introduction of a hydroxyl group in the polyimide resin constituting the binder can improve the adhesion between the polyimide resin and the negative electrode active material particles whose surfaces have high polarity. Thus, a lithium secondary battery having good charge-discharge cycle characteristics can be obtained by using the negative electrode for lithium secondary batteries according to the present invention.

A carboxyl group, which has high polarity like the hydroxyl group, may also be used as a functional group and is also believed to improve the adhesion with the negative electrode active material particles. This means that a diamine having a carboxyl group can be used instead of the diamine having a hydroxyl group. However, if a diamine having a carboxyl group is used, the carboxyl group may react with an amino group of the other diamines, forming an amide bond. As a result, a polyamide-imide resin is produced and a polyimide resin is may not be suitably produced. Therefore, a diamine having a hydroxyl group is preferably used in the present invention.

In the present invention, the diamine having a hydroxyl group may be a diamine having a single hydroxyl group or a diamine having two or more hydroxyl groups. Among these diamines, a diamine having a single hydroxyl group is preferably used. This is because the polymerization reaction between tetracarboxylic acid and diamine is more easily facilitated with a diamine having a single hydroxyl group than the case where a diamine having two or more hydroxyl groups is used.

An example of the diamine having a single hydroxyl group is diaminomonohydroxybenzene (also referred to as diaminophenol). Examples of the diaminomonohydroxybenzene include 2,3-diaminophenol, 2,5-diaminophenol, 2,6-diaminophenol, 3,4-diaminophenol, and 3,5-diaminophenol represented by formula (1). Among them, 3,5-diaminophenol represented by the formula (1) is preferably used as the diamine having a single hydroxyl group. In 3,5-diaminophenol, two amino groups are present in meta-positions. With 3,5-diaminophenol, high flexibility and strength that are characteristics of polyimide resins can be achieved. The hydroxyl group is oriented so as to be perpendicular to a molecular chain constituting the basic skeleton of the polyimide resin. Thus, a hydroxyl group is easily bonded to the negative electrode active material and the negative electrode current collector. This can provide better adhesion.

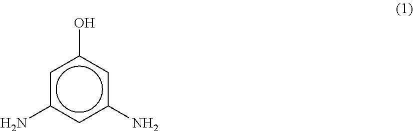

Examples of a diamine having two hydroxyl groups include diaminodihydroxybenzene, diaminodihydroxybenzophenone, diaminodihydroxybiphenyl, diaminodihydroxydiphenylmethane, diaminodihydroxydiphenyl ether, and diaminodihydroxydiphenyl sulfone. Examples of the diaminodihydroxybenzene include 1,3-diamino-4,5-dihydroxybenzene and 1,3-diamino-4,6-dihydroxybenzene. Examples of the diaminodihydroxybenzophenone include 3,3′-diamino-4,4′-dihydroxybenzophenone, 4,4′-diamino-3,3′-dihydroxybenzophenone, and 4,4′-diamino-2,2′-dihydroxybenzophenone. Examples of the diaminodihydroxybiphenyl include 3,3′-diamino-4,4′-dihydroxybiphenyl, 4,4′-diamino-3,3′-dihydroxybiphenyl, and 4,4′-diamino-2,2′-dihydroxybiphenyl. Examples of the diaminodihydroxydiphenylmethane include 3,3′-diamino-4,4′-dihydroxydiphenylmethane, 4,4′-diamino-3,3′-dihydroxydiphenylmethane, and 4,4′-diamino-2,2′-dihydroxydiphenylmethane. Examples of the diaminodihydroxydiphenyl ether include 3,3′-diamino-4,4′-dihydroxydiphenyl ether, 4,4′-diamino-3,3′-dihydroxydiphenyl ether, and 4,4′-diamino-2,2′-dihydroxydiphenyl ether. Examples of the diaminodihydroxydiphenyl sulfone include 3,3′-diamino-4,4′-dihydroxydiphenyl sulfone, 4,4′-diamino-3,3′-dihydroxydiphenyl sulfone, and 4,4′-diamino-2,2′-dihydroxydiphenyl sulfone.

An example of a diamine having three hydroxyl groups is diaminotrihydroxybenzene such as 1,3-diamino-4,5,6-trihydroxybenzene.

Examples of a diamine having four hydroxyl groups include diaminotetrahydroxybenzene, diaminotetrahydroxybenzophenone, diaminotetrahydroxybiphenyl, diaminotetrahydroxydiphenylmethane, diaminotetrahydroxydiphenyl ether, and diaminotetrahydroxydiphenyl sulfone. An example of the diaminotetrahydroxybenzene is 1,3-diamino-2,4,5,6-tetrahydroxybenzene. An example of the diaminotetrahydroxybenzophenone is 4,4′-diamino-2,2′,5,5′-tetrahydroxybenzophenone. A specific example of the diaminotetrahydroxybiphenyl is 4,4′-diamino-2,2′,5,5′-tetrahydroxybiphenyl. An example of the diaminotetrahydroxydiphenylmethane is 4,4′-diamino-2,2′,5,5′-tetrahydroxydiphenylmethane. An example of the diaminotetrahydroxydiphenyl ether is 4,4′-diamino-2,2′,5,5′-tetrahydroxydiphenyl ether. An example of the diaminotetrahydroxydiphenyl sulfone is 4,4′-diamino-2,2′,5,5′-tetrahydroxydiphenyl sulfone.

In the present invention, the tetracarboxylic acid used together with a diamine to form a polyimide resin may be a tetracarboxylic anhydride.

Examples of the tetracarboxylic anhydride include aromatic tetracarboxylic dianhydrides such as 1,2,4,5-benzenetetracarboxylic-1,2:4,5-dianhydride (also called pyromellitic dianhydride), 3,3′,4,4′-benzophenonetetracarboxylic dianhydride represented by formula (2), 3,3′,4,4′-biphenyltetracarboxylic dianhydride represented by formula (3), 3,3′,4,4′-diphenylsulfonetetracarboxylic dianhydride, 3,3′,4,4′-diphenylethertetracarboxylic dianhydride, and 3,3′,4,4′-diphenylmethanetetracarboxylic dianhydride. Among them, 3,3′,4,4′-benzophenonetetracarboxylic dianhydride and 3,3′,4,4′-biphenyltetracarboxylic dianhydride are preferably used as the tetracarboxylic anhydride. Since 3,3′,4,4′-benzophenonetetracarboxylic dianhydride and 3,3′,4,4′-biphenyltetracarboxylic dianhydride have a molecular structure in which two aromatic rings are positioned in the same plane, a polyimide resin having balanced mechanical strength and flexibility can be obtained.

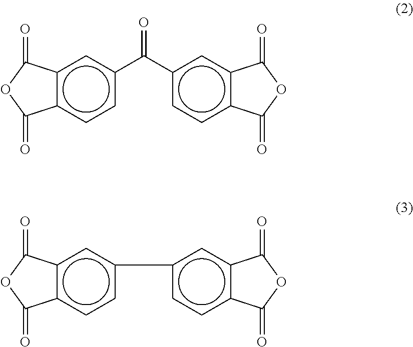

In the case where the diamine represented by the formula (1) and the tetracarboxylic anhydride represented by the formula (2) are employed, a polyimide resin having a structure represented by formula (4) is obtained. In the case where the diamine represented by the formula (1) and the tetracarboxylic anhydride represented by the formula (3) are employed, a polyimide resin having a structure represented by formula (5) is obtained.

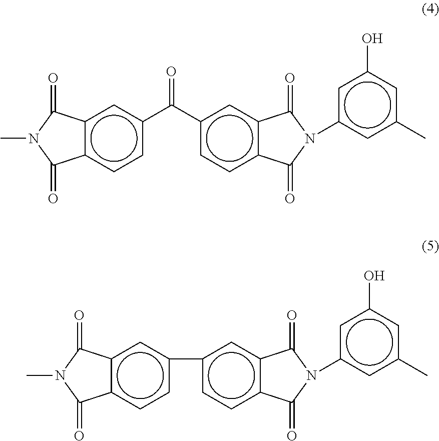

In the present invention, the diamine may be a diamine having a hydroxyl group. The binder may also be a polyimide resin formed by imidization of a tetracarboxylic acid or tetracarboxylic anhydride and a diamine having a hydroxyl group and a diamine having no hydroxyl group. By employing a diamine having no highly reactive hydroxyl group in addition to the diamine having a hydroxyl group, a polyimide resin having a high degree of polymerization and a high molecular weight is easily formed.

An example of the diamine having no hydroxyl group is an aromatic diamine. Examples of the aromatic diamine include m-phenylenediamine represented by formula (6), p-phenylenediamine, 3,3′-diaminobenzophenone, 4,4′-diaminobiphenyl, 4,4′-diaminodiphenylsulfone, 4,4′-diaminophenyl ether, 4,4′-diaminophenylmethane, 2,2-bis(4-(4-aminophenoxy)phenyl)propane, 1,4-bis(3-aminophenoxy)benzene, and 1,4-bis(4-aminophenoxy)benzene. Among them, m-phenylenediamine represented by the formula (6) is preferably used. In m-phenylenediamine, an amino group is bonded to a meta-position of a single aromatic ring. With m-phenylenediamine, a polyimide resin having balanced mechanical strength and flexibility can be obtained.

In the case where m-phenylenediamine represented by the formula (6) and the tetracarboxylic anhydride represented by the formula (2) are employed, a polyimide resin having a structure represented by formula (7) is obtained. In the case where m-phenylenediamine represented by the formula (6) and the tetracarboxylic anhydride represented by the formula (3) are employed, a polyimide resin having a structure represented by formula (8) is obtained.

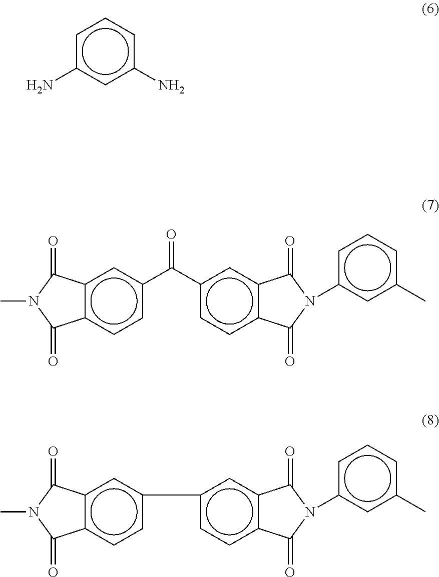

When both the diamine having a hydroxyl group and the diamine having no hydroxyl group are employed, the ratio between the diamine having a hydroxyl group and the diamine having no hydroxyl group is preferably 10:90 to 50:50 and more preferably 10:90 to 30:70. If the content of the diamine having no hydroxyl group is excessively low and the content of the diamine having a hydroxyl group is excessively high, a high degree of polymerization sometimes cannot be achieved. If the content of the diamine having no hydroxyl group is excessively high and the content of the diamine having a hydroxyl group is excessively low, the adhesion in the negative electrode is decreased and thus the cycle lifetime of lithium secondary batteries is sometimes shortened.

In the present invention, the negative electrode current collector is not particularly limited as long as it has conductivity. The negative electrode current collector can be composed of, for example, a conductive metal foil. Examples of the conductive metal foil include foils composed of a metal such as copper, nickel, iron, titanium, cobalt, manganese, tin, silicon, chromium, or zirconium or an alloy containing at least one of the foregoing metals. Among them, a copper thin film or a foil composed of an alloy containing copper is preferred because the conductive metal foil preferably contains a metal element that easily diffuses into active material particles.

The thickness of the negative electrode current collector is not particularly limited, and may be, for example, about 10 m to 100 m.

In the present invention, the negative electrode active material particles are not particularly limited as long as they contain at least one of silicon and a silicon alloy. The silicon alloy is not particularly limited as long as it is an alloy that functions as a negative electrode active material. Examples of the silicon alloy include a solid solution, an intermetallic compound, and an eutectic alloy of silicon and at least one element other than silicon. The silicon alloy can be produced by arc melting, liquid quenching, mechanical alloying, sputtering, chemical vapor deposition, firing, or the like. Examples of the liquid quenching include single-roller quenching, double-roller quenching, and various atomization processes such as a gas atomization process, a water atomization process, and a disk atomization process.

The negative electrode active material particles may be particles that are composed of at least one of silicon and a silicon alloy and whose surfaces are coated with a metal or an alloy. Examples of the coating method include electroless plating, electroplating, chemical reduction, vapor deposition, sputtering, and chemical vapor deposition. The metal that coats the surfaces of particles is preferably the same metal as that used for the conductive metal foil constituting the negative electrode current collector or the conductive metal powder below. By coating the particles with the same metal as that used for the conductive metal foil or the conductive metal powder, the linkage between the current collector and the conductive metal powder during sintering is considerably improved, resulting in better charge-discharge cycle characteristics.

The average particle size of the negative electrode active material particles is not particularly limited, and is, for example, preferably 100 m or less and more preferably 50 m or less.

In the present invention, the negative electrode mixture layer may further contain conductive powder such as conductive metal powder or conductive carbon powder. Preferably, the conductive metal powder may be composed of the same material as that of the conductive metal foil used as the negative electrode current collector. Powder composed of a metal such as copper, nickel, iron, titanium, or cobalt or an alloy of the foregoing is preferably used as the conductive metal powder. The average particle size of the conductive powder is not particularly limited, and is preferably 100 m or less and more preferably 50 m or less.

Monomer components other than the diamine and the at least one of a tetracarboxylic acid and a tetracarboxylic dianhydride may be used to form the polyimide resin. Examples of the monomer components other than the diamine include hexavalent or higher polycarboxylic acids, hexavalent or higher polycarboxylic acid anhydrides, and trivalent or higher polyamines.

The polycarboxylic acid and polycarboxylic acid anhydride react with a diamine or a polyamine during the heat treatment performed after the application and drying of negative electrode mixture slurry. The polyamine also reacts with a tetracarboxylic anhydride or the like during the heat treatment performed after the application and drying of negative electrode mixture slurry. Since a crosslinked structure can be introduced in the polyimide resin through these reactions, a polyimide resin having higher mechanical strength can be obtained. As a result, the charge-discharge cycle characteristics can be further improved.

Examples of the polycarboxylic acid include benzenehexacarboxylic acid (mellitic acid) and 1,2,3,4,5,6-cyclohexanehexacarboxylic acid. Examples of the polycarboxylic acid anhydride include benzenehexacarboxylic acid (mellitic acid) anhydride and 1,2,3,4,5,6-cyclohexanehexacarboxylic acid anhydride.

Examples of the polyamine include aromatic triamines such as tris(4-aminophenyl)methanol (also called pararosaniline), tris(4-aminophenyl)methane, 3,4,4′-triaminodiphenyl ether, 3,4,4′-triaminobenzophenone, 3,4,4′-triaminodiphenylmethane, 1,4,5-triaminonaphthalene, tris(4-aminophenyl)amine, 1,2,4-triaminobenzene, and 1,3,5-triaminobenzene; triamines such as 2,4,6-triamino-1,3,5-triazine (also called melamine) and 1,3,5-triaminocyclohexane; and tetraamines such as tetrakis(4-aminophenyl)methane, 3,3′,4,4′-tetraminodiphenyl ether, 3,3′,4,4′-tetraminobenzophenone, 3,3′,4,4′-tetraminodiphenylmethane, and N,N,N′,N′-tetrakis(4-methylphenyl)benzidine.

The production method of the negative electrode for lithium secondary batteries according to the present invention is not particularly limited. The negative electrode for lithium secondary batteries according to the present invention can be produced, for example, through the following process.

First, a binder precursor solution is prepared. Specifically, a tetracarboxylic dianhydride is caused to react with an alcohol compound having a single hydroxyl group, such as a monohydric alcohol (e.g., methanol, ethanol, isopropanol, and butanol), in a solvent to form an ester compound of the tetracarboxylic dianhydride with an alcohol. A diamine having a hydroxyl group is added to the resultant solution to prepare a binder precursor solution containing monomer components of a polyimide resin.

Negative electrode active material particles are then dispersed in the binder precursor solution to prepare a negative electrode mixture slurry. The negative electrode mixture slurry is applied on the surface of a negative electrode current collector. The negative electrode current collector on which the negative electrode mixture slurry has been applied is heat-treated in a non-oxidizing atmosphere to cause polymerization reaction and imidization reaction between the monomer components of a polyimide resin, whereby a polyimide resin is formed. As a result, a negative electrode for lithium secondary batteries including a negative electrode active material layer formed on the negative electrode current collector can be completed.

In the above-described production method, the binder precursor solution used to form the negative electrode active material layer and containing monomer components of a polyimide resin has a lower viscosity than a binder precursor in a polymer state, such as polyamic acid, which is commonly used as a precursor of a polyimide resin. Therefore, when the negative electrode mixture slurry is prepared, the binder precursor solution containing monomer components of a polyimide resin easily enters the uneven surfaces of the negative electrode active material particles. Furthermore, when the negative electrode mixture slurry is applied on the negative electrode current collector, the binder precursor solution easily enters the uneven surface of the negative electrode current collector. This produces a significant anchor effect between the negative electrode active material particles and between the negative electrode active material particles and the negative electrode current collector. Thus, the adhesion between the negative electrode mixture layer and the negative electrode current collector can be further improved.

In the production method of the negative electrode, the heat treatment temperature of the negative electrode mixture slurry that has been applied and dried is preferably lower than the 5% mass decrease temperature of a negative electrode binder. In the case where the negative electrode binder has glass transition temperature, the heat treatment temperature of the negative electrode mixture slurry is preferably higher than the glass transition temperature of the negative electrode binder. In this case, since the negative electrode binder has plasticity, the binder more easily enters the uneven surfaces of the negative electrode active material particles or negative electrode current collector. Consequence, an anchor effect is produced more significantly, which can provide better adhesion.

A lithium secondary battery according to the present invention includes an electrode body including the negative electrode for lithium secondary batteries according to the present invention, a positive electrode, and a separator disposed between the negative electrode and the positive electrode, and a non-aqueous electrolyte impregnated into the electrode body. As described above, the negative electrode for lithium secondary batteries according to the present invention has good adhesion. Thus, a lithium secondary battery including the negative electrode for lithium secondary batteries according to the present invention has good charge-discharge cycle characteristics.

In the present invention, the positive electrode, the separator, and the non-aqueous electrolyte are not particularly limited. For example, a known positive electrode, separator, and non-aqueous electrolyte can be used.

The positive electrode normally includes a positive electrode current collector composed of a conductive metal foil or the like and a positive electrode mixture layer formed on the positive electrode current collector. The positive electrode mixture layer contains a positive electrode active material. The positive electrode active material is not particularly limited as long as lithium is electrochemically inserted and removed. Examples of the positive electrode active material include lithium transition metal oxides such as LiCoO₂, LiNiO₂, LiMn₂O₄, LiMnO₂, LiCO_{0.5}Ni_{0.5}O₂, and LiNi_{0.7}CO_{0.2}Mn_{0.1}O₂ and metal oxides not containing lithium such as MnO₂.

A solvent used for the non-aqueous electrolyte is also not particularly limited. Examples of the solvent used for the non-aqueous electrolyte include cyclic carbonates such as ethylene carbonate, propylene carbonate, butylene carbonate, and fluoroethylene carbonate; chain carbonates such as dimethyl carbonate, methylethyl carbonate, and diethyl carbonate; and mixed solvents of the cyclic carbonates and the chain carbonates.

A solute used for the non-aqueous electrolyte is also not particularly limited. Examples of the solute used for the non-aqueous electrolyte include LiPF₆, LiBF₄, LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, and the mixtures of the foregoing. A gel polymer electrolyte obtained by impregnating a polymer electrolyte such as polyethylene oxide or polyacrylonitrile with an electrolytic solution and an inorganic solid electrolyte such as LiI or Li₃N may be used as the electrolyte.

The non-aqueous electrolyte preferably contains CO₂.

According to the present invention, there can be provided a lithium secondary battery that uses at least one of silicon and a silicon alloy as a negative electrode active material and thus has good charge-discharge cycle characteristics.

### BRIEF DESCRIPTION OF THE SEVERAL VIEWS OF THE DRAWINGS

FIG. 1 is a schematic perspective view of an electrode body.

FIG. 2 is a schematic plan view of a battery produced in Example 1.

FIG. 3 is a schematic sectional view taken along line III-III of FIG. 2.

### DETAILED DESCRIPTION OF THE INVENTION

The present invention will now be described in detail based on Examples. The present invention is not limited by Examples below, and any modification may be made without departing from the scope of the present invention.

### Example 1

### Preparation of Negative Electrode

### <Preparation of Negative Electrode Active Material>

First, polycrystalline silicon fine particles were introduced and monosilane (SiH₄) was inserted into a fluidized bed having an inside temperature of 800° C. to prepare particulate polycrystalline silicon. The particulate polycrystalline silicon was pulverized with a jet mill and classified with a classifier to prepare polycrystalline silicon powder (negative electrode active material). The median particle size of the polycrystalline silicon powder was 10 m. The crystallite size of the polycrystalline silicon powder was 44 nm.

Herein, the median particle size is a particle size when the cumulative distribution percentage by volume reaches 50%, the particle size distribution being measured by laser diffraction. The crystallite size of the polycrystalline silicon powder was calculated from the Scherrer equation using the half width of a (111) peak of silicon measured by powder X-ray diffractometry.

### <Preparation of Negative Electrode Binder Precursor>

A substance esterified through the reaction between 3,3′,4,4′-benzophenonetetracarboxylic dianhydride represented by formula (2) and two equivalents of ethanol, 3,5-diaminophenol (1,3-diamino-5-hydroxybenzene) represented by formula (1), and m-phenylenediamine represented by formula (6) were dissolved in N-methyl-2-pyrrolidone (NMP) to obtain a binder precursor solution a1. The molar ratio of (3,3′,4,4′-benzophenonetetracarboxylic dianhydride represented by formula (2)): (3,5-diaminophenol represented by formula (1)): (m-phenylenediamine represented by formula (6)) was adjusted to be 100:10:90.

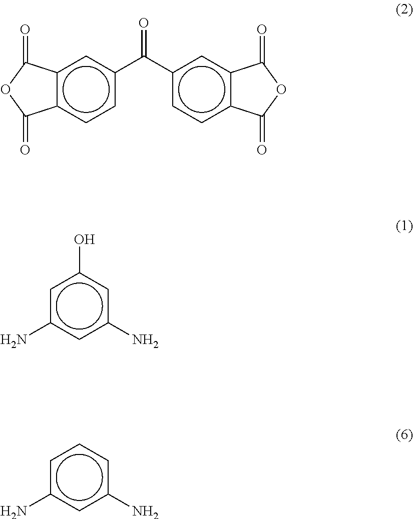

### <Preparation of Negative Electrode Mixture Slurry>

The negative electrode active material prepared above, graphite powder having an average particle size of 3 m and serving as a negative electrode conductive agent, and the negative electrode binder precursor solution a1 were mixed with each other to prepare a negative electrode mixture slurry. The mass ratio of (negative electrode active material powder):(negative electrode conductive agent powder):(negative electrode binder (obtained after the negative electrode binder precursor solution a1 was subjected to NMP removal by drying, polymerization reaction, and imidization reaction)) was adjusted to be 89.5:3.7:6.8.

### <Preparation of Negative Electrode>

Both faces of a copper alloy foil having a thickness of 18 m (C7025 alloy foil having a composition of 96.2 wt % of Cu, 3 wt % of Ni, 0.65 wt % of Si, and 0.15 wt % of Mg) were roughened by electrolysis so as to have a surface roughness Ra (JIS B 0601-1994) of 0.25 m and an average distance between local peaks S (JIS B 0601-1994) of 0.85 m. This was used as a negative electrode current collector.

The negative electrode mixture slurry prepared above was applied on both faces of the negative electrode current collector in air at 25° C., dried in air at 120° C., and rolled in air at 25° C. After the rolling, the resultant body was cut into rectangles each having a length of 380 mm and a width of 52 mm and then heat-treated in an argon atmosphere at 400° C. for 10 hours. Thus, a negative electrode including negative electrode mixture layers formed on both faces of the negative electrode current collector was prepared.

The amount of the negative electrode mixture layers formed on the negative electrode current collector was 5.6 mg/cm² and the thickness of each of the negative electrode mixture layers was 56 m.

Lastly, a nickel plate serving as a negative electrode current collector tab was connected to the end portion of the negative electrode.

The following experiment was performed in order to confirm whether a polyimide compound was produced from the binder precursor solution 1a through heat treatment. The binder precursor solution a1 was dried in air at 120° C. to remove NMP, and then heat-treated in an argon atmosphere at 400° C. for 10 hours as in the heat treatment described above. The infrared (IR) absorption spectrum of the resultant body was measured. A peak derived from an imide bond was detected at about 1720 cm⁻¹. Accordingly, it was confirmed that polymerization reaction and imidization reaction were caused through the heat treatment of the binder precursor solution a1 and thus a polyimide compound was produced.

### [Preparation of Positive Electrode]

### <Preparation of Lithium Transition Metal Compound Oxide>

Li₂CO₃ and CoCO₃ serving as positive electrode active materials were mixed with each other in a mortar so that the molar ratio between Li and Co was 1:1, heat-treated in air at 800° C. for 24 hours, and then pulverized. Consequently, a lithium-cobalt compound oxide powder represented by LiCoO₂ and having an average particle size of 11 m was obtained. In Example 1, this lithium-cobalt compound oxide powder was used as a positive electrode active material powder.

The BET specific surface of the resultant positive electrode active material powder was 0.37 m²/g.

### <Preparation of Positive Electrode>

The positive electrode active material powder prepared above, a carbon material powder serving as a positive electrode conductive agent, and polyvinylidene fluoride serving as a positive electrode binder were added to N-methyl-2-pyrrolidone serving as a dispersion medium, and the mixture was kneaded to prepare a positive electrode mixture slurry. The mass ratio of (positive electrode active material powder):(positive electrode conductive agent):(positive electrode binder) was adjusted to be 95:2.5:2.5.

The positive electrode mixture slurry was applied on both faces of an aluminum foil serving as a positive electrode current collector and having a thickness of 15 m, a length of 402 mm, and a width of 50 mm, dried, and then rolled. The coated portion on the front face had a length of 340 mm and a width of 50 mm. The coated portion on the back face had a length of 270 mm and a width of 50 mm. The amount of the positive electrode mixture layers formed on both faces of the current collector was 48 mg/cm². The thickness of the positive electrode in a portion where the positive electrode mixture layers were formed on both faces of the current collector was 143 m.

Lastly, an aluminum plate serving as a positive electrode current collector tab was connected to the positive electrode current collector in a portion where the positive electrode mixture layer was not formed.

### [Preparation of Non-Aqueous Electrolyte]

After 1 mol/L lithium hexafluorophosphate (LiPF₆) was dissolved, in an argon atmosphere, in a solvent obtained by mixing fluoroethylene carbonate (FEC) and methylethyl carbonate (MEC) in a volume ratio of 2:8, 0.4 wt % of carbon dioxide gas was dissolved therein to prepare a non-aqueous electrolyte.

### [Preparation of Electrode Body]

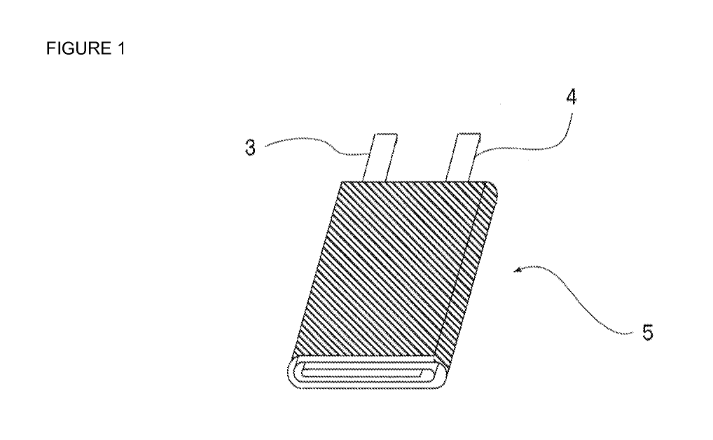

The above-described positive electrode, the above-described negative electrode, and two separators made of a polyethylene microporous membrane were prepared. Each of the separators made of a polyethylene microporous membrane had a thickness of 20 m, a length of 450 mm, a width of 54.5 mm, a piercing strength of 340 g, and a porosity of 39%. The positive electrode, the negative electrode, and the separators were wound around a columnar core in a spiral form so that the positive electrode and the negative electrode faced each other with the separators therebetween and the positive electrode current collector tab and the negative electrode current collector tab came to be located at the outermost periphery. After that, the core was removed to prepare a spiral electrode body. The electrode body was then pressed to obtain an electrode body shown in FIG. 1.

As shown in FIG. 1, the obtained electrode body 5 is flat and includes a positive electrode current collector tab 3 and a negative electrode current collector tab 4.

### [Production of Battery]

The flat electrode body and electrolyte prepared above were inserted in a casing made of an aluminum laminate in a carbon dioxide atmosphere of 25° C. and 1 atmospheric pressure to produce a flat battery A1 according to Example 1.

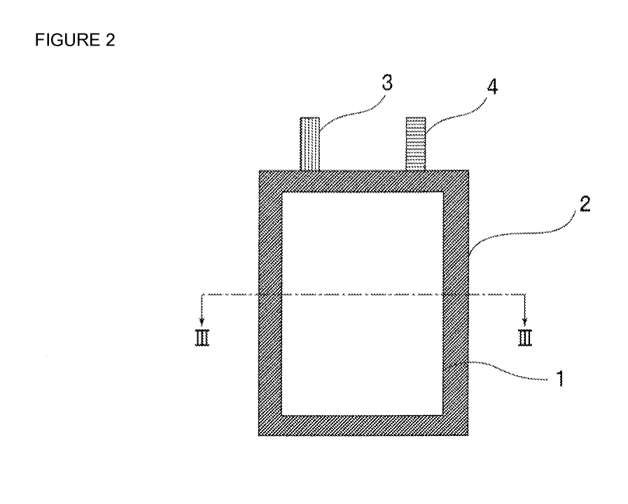

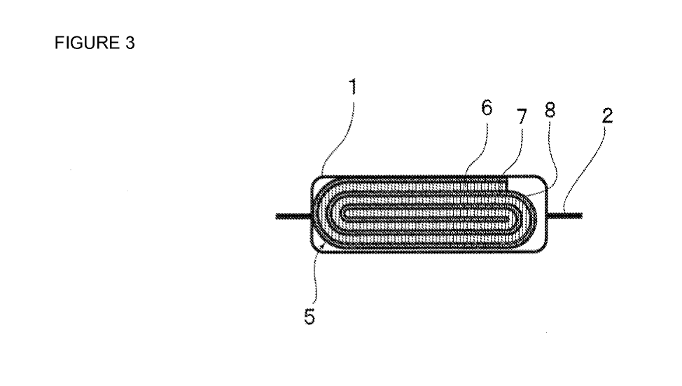

FIG. 2 is a schematic plan view of the battery A1. FIG. 3 is a schematic sectional view of the battery A1.

As shown in FIGS. 2 and 3, the battery A1 includes a flat electrode body 5 having a positive electrode 6, a negative electrode 7, separators 8, a positive electrode current collector tab 3, and a negative electrode current collector tab 4. The flat electrode body 5 is accommodated in a casing 1 made of an aluminum laminate and having a sealed portion 2 subjected to heat seal treatment.

### Example 2

A flat battery A2 according to Example 2 was produced by the same method as in Example 1, except that the binder precursor solution was prepared so that the molar ratio of (3,3′,4,4′-benzophenonetetracarboxylic dianhydride represented by formula (2)): (3,5-diaminophenol represented by formula (1)): (m-phenylenediamine represented by formula (6)) was adjusted to be 100:30:70.

### Example 3

A flat battery A3 according to Example 3 was produced by the same method as in Example 1, except that the binder precursor solution was prepared so that the molar ratio of (3,3′,4,4′-benzophenonetetracarboxylic dianhydride represented by formula (2)): (3,5-diaminophenol represented by formula (1)): (m-phenylenediamine represented by formula (6)) was adjusted to be 100:50:50.

### Example 4

A flat battery A4 according to Example 4 was produced by the same method as in Example 1, except that 3,3′,4,4′-biphenyltetracarboxylic dianhydride represented by formula (3) was used instead of 3,3′,4,4′-benzophenonetetracarboxylic dianhydride represented by formula (2).

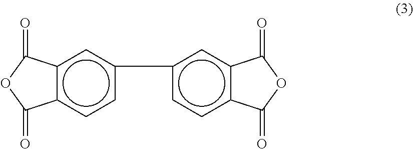

### Example 5

A flat battery A5 according to Example 5 was produced by the same method as in Example 2, except that 3,3′,4,4′-biphenyltetracarboxylic dianhydride represented by formula (3) was used instead of 3,3′,4,4′-benzophenonetetracarboxylic dianhydride represented by formula (2).

### Example 6

A flat battery A6 according to Example 6 was produced by the same method as in Example 3, except that 3,3′,4,4′-biphenyltetracarboxylic dianhydride represented by formula (3) was used instead of 3,3′,4,4′-benzophenonetetracarboxylic dianhydride represented by formula (2).

### Comparative Example 1

A flat battery B1 according to Comparative Example 1 was produced by the same method as in Example 1, except that the binder precursor solution was prepared without using 3,5-diaminophenol represented by formula (1) so that the molar ratio of (3,3′,4,4′-benzophenonetetracarboxylic dianhydride represented by formula (2)): (m-phenylenediamine represented by formula (6)) was adjusted to be 100:100.

### Comparative Example 2

A flat battery B2 according to Comparative Example 2 was produced by the same method as in Example 2, except that the binder precursor solution was prepared without using 3,5-diaminophenol represented by formula (1) so that the molar ratio of (3,3′,4,4′-biphenyltetracarboxylic dianhydride represented by formula (3)): (m-phenylenediamine represented by formula (6)) was adjusted to be 100:100.

### [Evaluation of Charge-Discharge Cycle Characteristics]

Regarding the batteries A1 to A6, B1, and B2, the charge-discharge cycle characteristics were evaluated under the following charge-discharge cycle conditions. Table 1 shows the results.

### Charge-Discharge Cycle Conditions

Charge Conditions at the First Cycle

After a constant-current charge was performed at a current of 50 mA for 4 hours, a constant-current charge was performed at a current of 200 mA until the battery voltage reached 4.2 V and then a constant-voltage charge was performed at a voltage of 4.2 V until the current value reached 50 mA.

Discharge Conditions at the First Cycle

A constant-current discharge was performed at a current of 200 mA until the battery voltage reached 2.75 V.

Charge Conditions at the Second and Subsequent Cycles

A constant-current charge was performed at a current of 1000 mA until the battery voltage reached 4.2 V, and then a constant-voltage charge was performed at a voltage of 4.2 V until the current value reached 50 mA.

Discharge Conditions at the Second and Subsequent Cycles

A constant-current discharge was performed at a current of 1000 mA until the battery voltage reached 2.75 V.

Subsequently, the initial charge-discharge efficiency and the cycle lifetime were determined by the following calculation methods. Table 1 shows the results.

Initial charge-discharge efficiency=(Discharge capacity at the first cycle)/(Charge capacity at the first cycle)100

Cycle lifetime: the number of cycles when the capacity retention ratio reached 90%

Herein, the capacity retention ratio is a value determined by dividing the discharge capacity at the nth cycle by the discharge capacity at the first cycle.

TABLE 1

| | Negative electrode binder | | | | | | Charge-discharge | |
|---|---|---|---|---|---|---|---|---|
| | Tetracarboxylic | | Diamine | | Diamine | | cycle characteristics | |
| | dianhydride | | (with hydroxyl group) | | (without hydroxyl group) | | Initial charge- | |
| Battery | Structure | Molar ratio | Structure | Molar ratio | Structure | Molar ratio | discharge efficiency | Cycle lifetime |
| Battery A1 | Formula (2) | 100 | Formula (1) | 10 | Formula (6) | 90 | 88 | 95 |
| Battery A2 | Formula (2) | 100 | Formula (1) | 30 | Formula (6) | 70 | 88 | 94 |
| Battery A3 | Formula (2) | 100 | Formula (1) | 50 | Formula (6) | 50 | 88 | 88 |
| Battery A4 | Formula (3) | 100 | Formula (1) | 10 | Formula (6) | 90 | 88 | 94 |
| Battery A5 | Formula (3) | 100 | Formula (1) | 30 | Formula (6) | 70 | 88 | 94 |
| Battery A6 | Formula (3) | 100 | Formula (1) | 50 | Formula (6) | 50 | 87 | 89 |
| Battery B1 | Formula (2) | 100 | — | 0 | Formula (6) | 100 | 87 | 75 |
| Battery B2 | Formula (3) | 100 | — | 0 | Formula (6) | 100 | 86 | 70 |

As is clear from the results shown in Table 1, the batteries A1 to A6 that used a diamine having a hydroxyl group had a charge-discharge cycle lifetime longer than that of the batteries B1 and B2 that used a diamine having no hydroxyl group. This is probably due to improved the adhesion between the polyimide resin and the negative electrode active material particles.

As is also clear from the comparison of the batteries A1 to A3 and the comparison of the batteries A4 to A6, the cycle lifetime of lithium secondary batteries can be further lengthened by adjusting the molar ratio between the diamine having a hydroxyl group and the diamine having no hydroxyl group to be 10:90 to 30:70.

While detailed embodiments have been used to illustrate the present invention, to those skilled in the art, however, it will be apparent from the foregoing disclosure that various changes and modifications can be made therein without departing from the spirit and scope of the invention. Furthermore, the foregoing description of the embodiments according to the present invention is provided for illustration only, and is not intended to limit the invention.

What is claimed is:

1. A negative electrode for lithium secondary batteries comprising:
a negative electrode current collector; and
a negative electrode active material layer formed on the negative electrode current collector,
wherein the negative electrode active material layer comprises a binder and negative electrode active material particles containing at least one of silicon and a silicon alloy,
wherein the binder is a polyimide resin formed by imidization of a tetracarboxylic acid or tetracarboxylic anhydride and a diamine comprising at least one hydroxyl group.

2. The negative electrode for lithium secondary batteries according to claim 1, wherein the diamine comprising at least one hydroxyl group is represented by formula (1) below

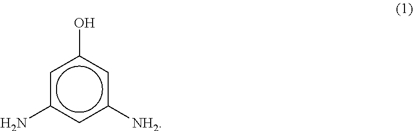

3. The negative electrode for lithium secondary batteries according to claim 2, wherein the binder is a polyimide resin formed by imidization of a tetracarboxylic anhydride and the diamine comprising at least one hydroxyl group,
wherein the tetracarboxylic anhydride contains at least one of a tetracarboxylic anhydride represented by formula (2) below and a tetracarboxylic anhydride represented by formula (3) below, and
the polyimide resin has at least one of a structure represented by formula (4) below and a structure represented by formula (5) below

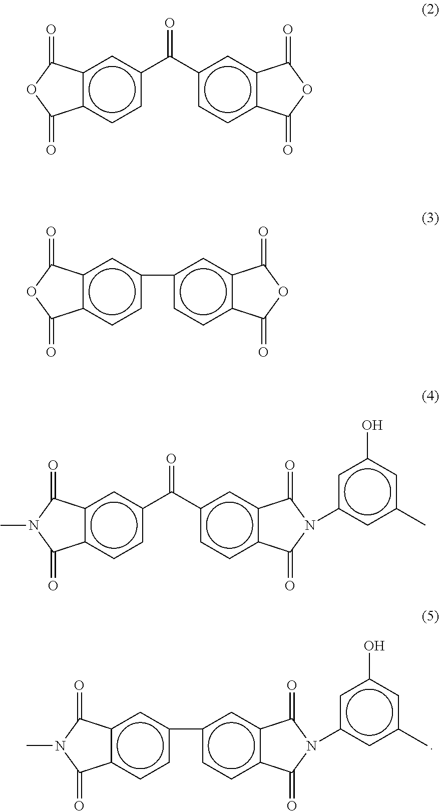

4. The negative electrode for lithium secondary batteries according to claim 1, wherein the polyimide resin is formed by imidization of a tetracarboxylic acid or tetracarboxylic anhydride and the diamine comprising at least one hydroxyl group and a diamine having no hydroxyl group.

5. The negative electrode for lithium secondary batteries according to claim 4, wherein the diamine having no hydroxyl group has a structure represented by formula (6) below, and
the polyimide resin has at least one of a structure represented by formula (7) below and a structure represented by formula (8) below

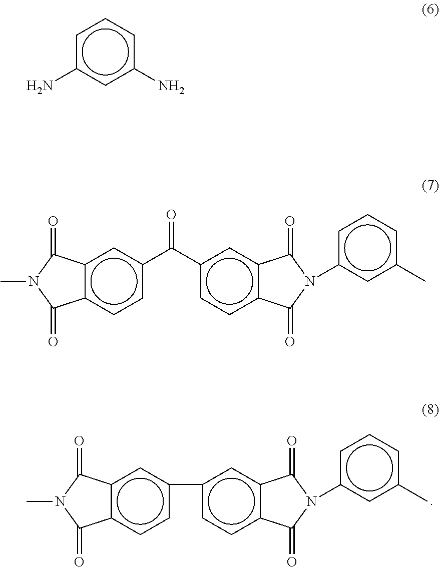

6. The negative electrode for lithium secondary batteries according to claim 4, wherein the molar ratio between the diamine having at least one hydroxyl group and the diamine having no hydroxyl group is 10:90 to 50:50.

7. A lithium secondary battery comprising:
an electrode body including the negative electrode for lithium secondary batteries according to claim 1, a positive electrode, and a separator disposed between the negative electrode and the positive electrode; and
a non-aqueous electrolyte impregnated into the electrode body.

8. A lithium secondary battery comprising:
an electrode body including the negative electrode for lithium secondary batteries according to claim 2, a positive electrode, and a separator disposed between the negative electrode and the positive electrode; and
a non-aqueous electrolyte impregnated into the electrode body.

9. A lithium secondary battery comprising:
an electrode body including the negative electrode for lithium secondary batteries according to claim 3, a positive electrode, and a separator disposed between the negative electrode and the positive electrode; and
a non-aqueous electrolyte impregnated into the electrode body.

10. A lithium secondary battery comprising:
an electrode body including the negative electrode for lithium secondary batteries according to claim 4, a positive electrode, and a separator disposed between the negative electrode and the positive electrode; and
a non-aqueous electrolyte impregnated into the electrode body.

11. A lithium secondary battery comprising:
an electrode body including the negative electrode for lithium secondary batteries according to claim 5, a positive electrode, and a separator disposed between the negative electrode and the positive electrode; and
a non-aqueous electrolyte impregnated into the electrode body.

12. A lithium secondary battery comprising:
an electrode body including the negative electrode for lithium secondary batteries according to claim 6, a positive electrode, and a separator disposed between the negative electrode and the positive electrode; and
a non-aqueous electrolyte impregnated into the electrode body.
